(19) United States
(12) Patent Application Publication
(10) Pub. No.: US 2013/0159431 A1
(43) Pub. Date: Jun. 20, 2013

(54) LOGO MESSAGE

(71) Applicants: Jeffrey B. Berry, Barnhart, MO (US); Lee Alexander Holmes, Saint Louis, MO (US)

(72) Inventors: Jeffrey B. Berry, Barnhart, MO (US); Lee Alexander Holmes, Saint Louis, MO (US)

(21) Appl. No.: 13/345,027

(22) Filed: Jan. 6, 2012

Related U.S. Application Data
(60) Provisional application No. 61/577,118, filed on Dec. 19, 2011.

(51) Int. Cl. G06F 15/16

(52) U.S. Cl. 709/206

(57) ABSTRACT

A method for augmenting any communication, text, iMessage, instant message, social media (i.e. Facebook, Twitter) and other such user interfaces and applications now known or shall be known in the future that provides the ability to insert and/or place logo, icon, symbol and other such material into individual message interfaces or character bubbles; providing further capability for an end user to “click” such material and subsequently be directed to any desired destination (i.e. content, web, video, audio, mobile, satellite, etc); user may be re-directed back to their original location prior to clicking on said material once desired.

Such system will provide for functionality and capabilities to be fully customizable to suit the requirements and desires of any network operator and any corresponding devices that may operate on or with such network; all functions and/or operations shall be either manual or automated and may be random or pre-determined in nature.

The presently disclosed subject matter relates generally to the placement and/or posting of logos, icons and symbols within an individual SMS/Text, MMS, iMessage, Blackberry Message, Instant Message, Twitter, Facebook, Samsung ChatOn and other similar Social and/or Messaging service, product, format, network, program and/or systems utilizing traditional or other commonly and globally accepted alphanumerical, image/text/audio/video/streaming and other such protocols within an SMS/Text, MMS, iMessage, Blackberry Message, Samsung ChatOn, Instant Message, Twitter, Facebook and other such Social and Media services, products, formats, networks, programs and/or systems character bubbles, message windows, interfaces and other such viewing displays; having the capability of manually or systematically configuring, setting or augmenting how often such logos, icons and/or symbols or series of logos, icons and/or symbols appear(s) within such message string(s) on any mobile handset, tablet or any device or system capable of sending and/or receiving and displaying or running such material, interface or corresponding Application Programming Interface (API) programming; with further capability of providing a mechanism and/or process for such mobile and/or other device(s), API and/or end user to be directed or re-directed to any linked and/or corresponding: data, website, mobile program, application, device, video, or other such information, materials and/or content, whether it be digitally connected and/or linked or related to said logo, icon and/or symbol in any medium or fashion; and shall provide further mechanism and/or process and the ability or functionality that provides for the end user to be directed or re-directed back to original SMS/Text, MMS, iMessage, Blackberry Message, Instant Message, Twitter, Facebook, Samsung ChatOn and other such Social and Media service, product, format, network, program and/or systems character bubble or other pre-programmed destination or assigned content on the end users or network and/or system mobile or other device(s). Furthermore, as it pertains to the aforementioned subject matter, all related content and other such digital information shall be transferable from one device to another, whether it is sent manually by an end user or in an automated fashion by any LM or other network, program, system and other such computing mechanisms. Any and all processes, functions and/or capabilities may be manual, automated, pre-determined or random. In addition, all LM capabilities and functionalities shall be customizable for any individual cellular carrier network or other systems and networks distributing LM material as well as provide similar customization for individual handset, tablet and other such device manufacturers.

### BACKGROUND

In today's digital environment, when an end user or other such person, computing network and the like is conducting any sort of SMS/Text, MMS, iMessage, Blackberry Message, Samsung ChatOn, Instant Message, Twitter, Facebook and other such communications from a typical mobile device (i.e. smart phone, cell phone, tablet or other such devices capable of sending and/or receiving such communications), it is customary to often find “emoticons” (any of several combinations of symbols used in electronic mail and text messaging to indicate the state of mind of the writer). As such, Logo Message (LM) aims to apply a similar model to an already widely accepted practice. For example, rather than the traditional methodology of an end user manually selecting and placing an emotional icon within an SMS/Text message bubble, LM will replace the traditional emoticon with a digitized company logo or any other such icon, image, symbol or other such material that has been selected by the network or system provider, advertiser, administrator, or authorized agents.

Furthermore, LM will insert such digital material at intervals that are either randomly selected, or via pre-determined intervals of message bubbles, interfaces, displays and/or screens. (See attached drawings)
In addition, LM will also provide the ability for the end user to click on such LM logo, image, symbol and/or icon material, and upon doing so, shall be directed to any pre-determined, automated or random: material, content and/or destination associated or pre-determined destination to the clicked material. Furthermore, as it relates to the aforementioned subject matter, LM will provide the capability for an individual user to easily share said content with any other end user or device capable of receiving said LM material. For example, if a person is communicating via iMessage with another person or device and they are viewing a live video stream, the originating user viewing the live video stream will be able to simply share that live video stream with another end user that is communicating with the originating user via iMessage or any other such communication and/or display product, service, protocol, format or device.

### SUMMARY

In accordance with an aspect of the presently disclosed subject matter, a way in which LM aims to achieve and a cursory understanding of how the product works and is managed are disclosed. Preferably, LM aims to increase the value of exposure of advertisers brands and provide a mechanism, channel or process in which advertisers are able to maximize brand exposure and brand equity and provide seamless and transparent transition for an end user to view said advertisers, community, individual or groups: digital, online, mobile, audio, visual, video and/or other content. That is, LM modifies the traditional SMS/Text, MMS, iMessage, Blackberry Message, Samsung ChatOn, Instant Message, Twitter, Facebook, Live Streams and other such like environments and provides a new pathway for advertisers, communities and persons to reach consumers, groups, companies and other such entities and individuals. Although LM may be most appreciated when used with a smart phone, tablet or device having the capability to view any such messages displaying the aforementioned icon, image, symbol, digital and audio and video material, the presently disclosed subject matter may also be used, and is within the scope of the present invention, when used with a device having any capability of viewing the LM format and materials. Further, although the following description is applied in a traditional, yet progressive format for sending and receiving LM material, it is contemplated and should be understood to be within the scope of the presently disclosed subject matter that the same modification may be applied to any product, system, network and/or device having an ability to display LM data or materials, whether they are displayed utilizing current technology or any devices, technologies, processes and/or methodologies that shall be made known in the future.

The foregoing summarizes only a few aspects of the presently disclosed subject matter and is not intended to be reflective of the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 is a slide illustrating how LM will appear to the end user in a typical, current era iPhone format. There is also a bulleted list of items giving a brief description of where the LM material will appear and how the LM material may be manually and/or systematically manipulated in order to set specific intervals between message bubbles.

FIG. 2 is a slide expounding upon FIG. 1 by illustrating the outcome an end user shall experience upon “Clicking” an LM logo/icon/symbol. The figure clearly shows that upon clicking the LM material, the user is then re-directed to the destination or content that has been programmed for that particular logo/icon/symbol.

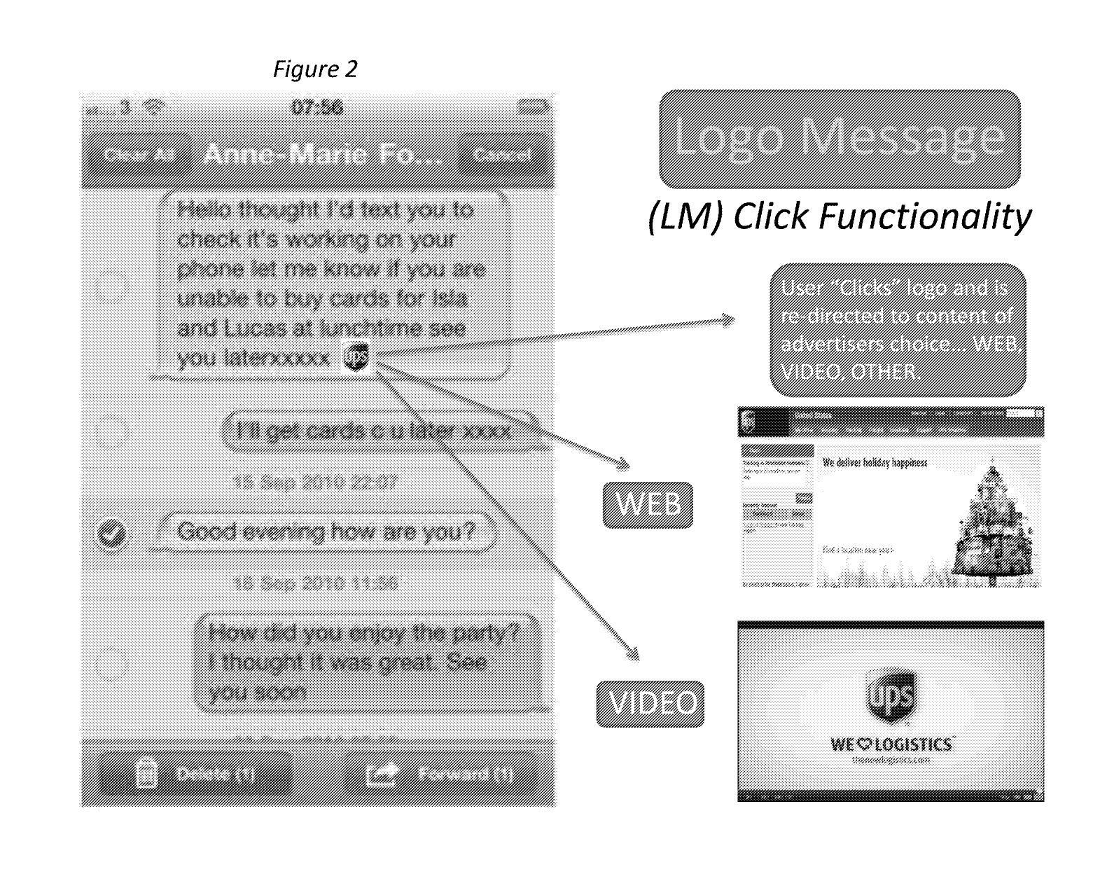

Any headings provided herein are for convenience only and do not necessarily affect the scope or meaning of the claimed presently disclosed subject matter.

### DETAILED DESCRIPTION OF ILLUSTRATIVE EMBODIMENTS

The subject matter of the various embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are only exemplary. The following description is illustrative and non-limiting to any one aspect.

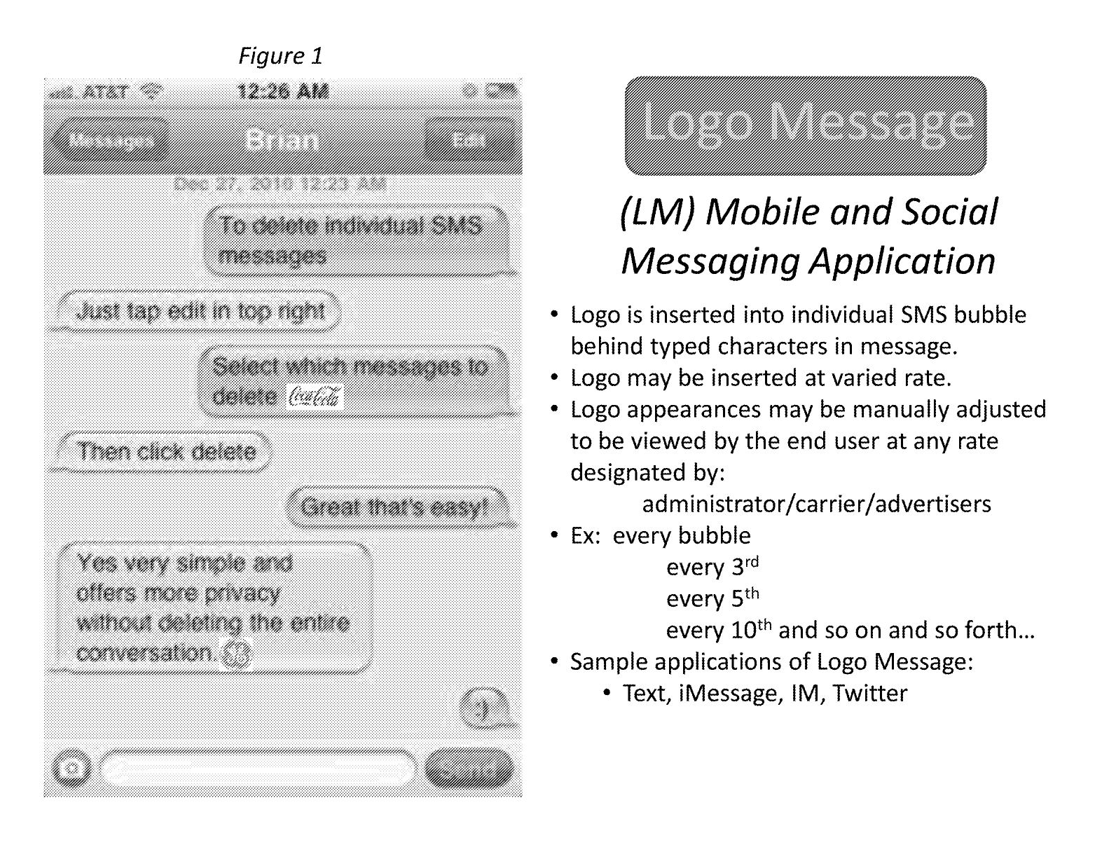

FIG. 1 is a slide illustrating in rudimentary form what LM will look like in a typical, current era iPhone format. There is also a bulleted list of items giving a brief description of where the LM material will appear and how the LM material may be manually and/or systematically manipulated in order to set specific intervals between message bubbles. As discussed above, the presently disclosed subject matter is not limited to the aforementioned devices but may be applied to various other systems, networks and devices capable of sending and receiving LM data and/or content today or at any time in the future.

### Additional Technical Aspects

Additional aspects are contemplated and are considered to be within the scope of the present invention. For example, an additional embodiment may include the coordination of the objects in a video having three dimensions along with the sounds of one of more of those objects or holographic capabilities and/or functionality.

Finally, it should also be noted that the various techniques described herein can be implemented in connection with hardware or software or, where appropriate, with a combination of both. Thus, the methods and apparatus of the presently disclosed subject matter, or certain aspects or portions thereof, can take the form of program code (i.e., instructions) embodied in tangible storage media, such as floppy diskettes, CD-ROMs, hard drives, or any other machine-readable storage medium, where, when the program code is loaded into and executed by a machine, such as a computer, the machine becomes an apparatus for practicing the subject matter. Other embodiments may include computer-readable instructions stored on a computer-readable medium, which when implemented by a processor, cause a computer to perform certain functions. Another embodiment may include a sound wave file or image file stored in a computer-readable storage medium that has been modified according to various aspects of the presently disclosed, subject matter and thereafter stored, on the same or other computer-readable storage medium.

In the case of program code execution on programmable computers, the computing device can generally include a processor, a storage medium readable by the processor (including volatile and non-volatile memory and/or storage elements), at least one input device, and at least one output device. One or more programs that can utilize the creation and/or implementation of domain-specific programming models aspects of the present invention, e.g., through the use of a data processing application programming interface (API) or the like, are preferably implemented in a high level procedural or object oriented programming language to communicate with a computer system. However, the program(s) can be implemented in assembly or machine language, if desired. In any case, the language can be a compiled or interpreted, language, and combined.

Finally, while the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods, systems, and computer readable media were described configured for modifying a widely accepted SMS/Text format according to aspects of the presently disclosed subject matter. However, other equivalent mechanisms to these described aspects are also contemplated by the teachings herein. Therefore, the present disclosure should not be limited to any single aspect, but rather construed in breadth and scope in accordance with the appended claims.

1. A method for modifying a traditional SMS/Text message, MMS, iMessage, Twitter, Facebook, Instant Message, Blackberry Message, Samsung ChatOn and other similar formats and products whether stored or displayed on a cellular device, tablet, and other such computer-readable storage medium, comprising: retrieving LM materials (i.e. logos/images/icons/symbols/audio/video/etc) stored on a computer-readable storage medium; and the placement, application, posting, displaying and/or sharing thereof such materials into a real-time or any other time formatted SMS/Text, MMS, iMessage, Blackberry Message, Twitter, Facebook, Samsung ChatOn, Instant Message, Bump and other Social and Media programs, products, services, environments, interfaces, windows, character bubbles and other such display areas, providing the ability for such LM materials to be displayed on any system, network and/or device capable of displaying said materials; and

2. Providing the capability to share, re-direct and/or direct an end user to pre-programmed or randomly selected locations and destinations (i.e. digital, internet, cellular, satellite, website, video, audio, mobile, content, programs, applications, live audio and live video streams of any kind) once a user “Clicks” said LM material.

3. Providing the mechanism, process and/or functionality to share, direct or re-direct an end user back to their original SMS/Text, MMS, iMessage, Blackberry Message, Samsung ChatOn, Twitter, Facebook, Instant Message and/or other such Social, Media and Live Streaming programs, products, services, environments, interfaces, windows and/or message or character bubble from the destination the end user was initially directed to via their Click on the original LM material. All content and other such digital information shall be transferable and/or shareable from one device to another, whether it is sent manually by an end user or in an automated fashion by any LM or other network, program, system and other such computing mechanisms.
